(19) United States
(12) Patent Application Publication
(10) Pub. No.: US 2022/0282029 A1
(43) Pub. Date: Sep. 8, 2022

(54) LOW BAND GAP GRAPHENE NANORIBBON ELECTRONIC DEVICES

(71) Applicant: THE REGENTS OF THE UNIVERSITY OF CALIFORNIA, OAKLAND, CA (US)

(72) Inventors: FELIX RAOUL FISCHER, BERKELEY, CA (US); JEFFREY BOKOR, PIEDMONT, CA (US); ZAFER MUTLU, WALNUT CREEK, CA (US); JUAN PABLO LLINAS, OAKLAND, CA (US); RYAN DAVID MCCURDY, BERKELEY, CA (US); GREGORY CLINTON VEBER, BERKELEY, CA (US); DHARATI JOSHI KOENIGS, PEARLAND, TX (US)

(21) Appl. No.: 17/608,355

(22) PCT Filed: May 29, 2020
(86) PCT No.: PCT/US2020/035128

§ 371 Date: Nov. 2, 2021

Related U.S. Application Data
(60) Provisional application No. 62/855,436, filed on May 31, 2019.

(51) Int. Cl. C08G 61/10; C01B 32/184

(52) U.S. Cl. CPC C08G 61/10; C01B 32/184; B82Y 40/00

(57) ABSTRACT

Various chemical structures of precursors for armchair graphene nanoribbons (AGNRs) are disclosed, along with a C method of manufacturing.

### CROSS REFERENCE TO RELATED APPLICATION

This application claims priority to and the benefit of U.S. Provisional Application No. 62/855,436 filed May 31, 2019, which is incorporated herein by reference in its entirety.

### STATEMENT REGARDING FEDERALLY SPONSORED RESEARCH AND DEVELOPMENT

This invention was made with government support under Grant Number DE-SC0010409 awarded by the Department of Energy and under Grant Number N00014-16-1-2921 awarded by the Office of Naval Research. The government has certain rights in the invention.

### TECHNICAL FIELD

This disclosure relates to graphene nanoribbons, more particularly to precursors to graphene nanoribbons that allow manufacture of N=11 and N=15 graphene nanoribbons, where N is the number of carbon atoms counted across the width of the ribbon.

### BACKGROUND

Graphene nanoribbons (GNRs) have promising electronic properties for high-performance, field-effect transistors and other electronic devices that have a channel between two terminals, where the terminals may be a source and drain, etc. Until recently, GNRs resulting from manufacturing processes such as unzipping carbon nanotubes, and lithographically defining GNRs from bulk graphene have rough edges that degrade electronic transport.

In newer techniques, a chemical synthesis process has produced ‘armchair’ GNRs (AGNRs) with precise edges. The AGNRs had widths of 9 carbon atoms, referred to here as N=9 AGNRs or 9AGNRS, and 13 molecules, or N=13 or 13AGNRs. However, when used in field effect transistors (FETs), the performance was limited by tunneling through the Schottky barrier, and a slightly larger band gap than desired.

### BRIEF DESCRIPTION OF THE DRAWINGS

FIG. 1 shows a synthesis sequence and images for N=7 graphene nanoribbon (GNR).

FIG. 2 shows a graph of band gap versus width in the number of carbon atoms for armchair GNRs (AGNRS).

FIG. 3 shows a schematic representation of molecular precursors for N=7 and N=13 AGNRs, and images of N=13 AGNRs.

FIG. 4A shows a schematic representation of a chemical structure of an embodiment of a precursor for N=9 and N=15 AGNRs.

FIGS. 4B-4C show an embodiment of a molecular precursor and alternative molecular precursors for N=15 AGNRs.

FIG. 5A shows a schematic representation of a chemical structure of an embodiment of a precursor for N=5 and N=11 AGNRs.

FIGS. 5B-5D show an embodiment of a molecular precursor, an x-ray crystal structure of the precursor, and alternative molecular precursors for N=11 AGNRs.

FIG. 6 shows an embodiment of a method of manufacturing an electronic device using AGNRs.

### DETAILED DESCRIPTION OF THE EMBODIMENTS

The embodiments here provide a novel approach to synthesize and engineer one-dimensional (1D) electronic materials for transistor and other electronic devices with ultimate scalability and performance involving graphene nanoribbons (GNRs). Recent breakthroughs allow chemical synthesis of GNRs from the bottom up using rational polymerization techniques. GNRs with uniform width in the 0.7-3.0 nm range, as well as atomically precise edges, can now be produced through self-assembly of highly purified polycyclic aromatic hydrocarbon monomers.

The present embodiments describe the design and synthesis of molecular precursors for low band gap armchair graphene nanoribbons (AGNRs) featuring a width of N=11 and N=15 carbon atoms. As used here, N is the number of carbon atoms counted in a zig-zag chain across the width and perpendicular to the long axis of the ribbon, their growth into AGNRs and their integration into functional electronic devices such as transistors.

The embodiments create a new GNR-based electronic device technology capable of pushing past currently projected limits for combining high current, meaning high speed, with high on/off ratio, meaning low power, in the operation of ultra-scaled digital electronics. These GNR nanostructures have great promise in this regard since they exhibit uniform, homogeneous, and ultra-narrow ribbon width, atomically smooth edges, and uniform bandgap. They are anticipated to exhibit excellent electron transport characteristics and would potentially make them ideal for use as the channel material in post-silicon CMOS transistors and other electronic devices, enabling the ultimate scaling of high performance digital electronics (Luisier, M.; Lundstrom, M.; Antoniadis, D. A.; Bokor, J., Ultimate device scaling: intrinsic performance comparisons of carbon-based, InGaAs, and Si field-effect transistors for 5 nm gate length. 2011 Ieee International Electron Devices Meeting (Iedm) 2011 [Luisier, et. al.]).

Further, GNR 1D heterostructures have recently been grown, in which the ribbon width, referred to here as the bandgap, varies along the length of the ribbon, opening up possibilities for novel tunneling devices with super-steep subthreshold slope for ultra-low voltage operation (Smith, S.; Llinas, J. P.; Bokor, J.; Salahuddin, S., Negative Differential Resistance and Steep Switching in Chevron Graphene Nanoribbon Field-Effect Transistors. Ieee Electr Device L 2018, 39 (1), 143-146).

The inventors have synthesized several distinct GNR structures, developed fabrication processes to integrate them into FET devices and to characterize their electrical operation, (Bennett, P. B.; Pedramrazi, Z.; Madani, A.; Chen, Y. C.; de Oteyza, D. G.; Chen, C.; Fischer, F. R.; Crommie, M. F.; Bokor, J., “Bottom-up graphene nanoribbon field-effect transistors.”Appl. Phys. Lett. 2013, 103 (25), 253114 [Bennett, et. al.], and Llinas, J. P.; Fairbrother, A.; Barin, G. B.; Shi, W.; Lee, K.; Wu, S.; Choi, B. Y.; Braganza, R.; Lear, J.; Kau, N.; Choi, W.; Chen, C.; Pedramrazi, Z.; Dumslaff, T.; Narita, A.; Feng, X. L.; Mullen, K.; Fischer, F.; Zettl, A.; Ruffieux, P.; Yablonovitch, E.; Crommie, M.; Fasel, R.; Bokor, J., “Short-channel field-effect transistors with 9-atom and 13-atom wide graphene nanoribbons.” Nat. Comm. 2017, 8 [Llinas, et. al.]). The first results in Bennett, et. al. were obtained using “N=7” AGNRs with only 0.7 nm width, corresponding to a 3.9 eV bandgap. The synthesis route for these ribbons was first demonstrated in “Cai, J. M.; Ruffieux, P.; Jaafar, R.; Bieri, M.; Braun, T.; Blankenburg, S.; Muoth, M.; Seitsonen, A. P.; Saleh, M.; Feng, X. L.; Müllen, K.; Fasel, R., “Atomically precise bottom-up fabrication of graphene nanoribbons.” Nature 2010, 466 (7305), 470-473, [Cai, et. al.]” and subsequently reproduced by the inventors.

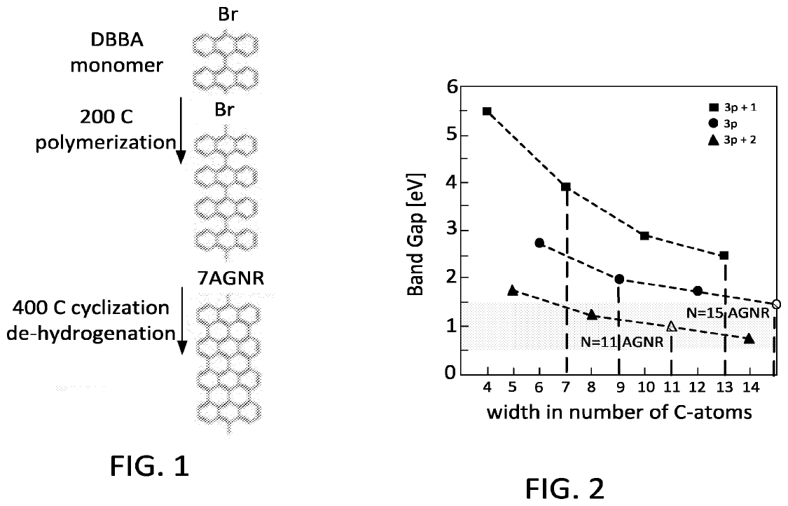

FIG. 1 shows an embodiment of the process. The precursor monomer molecule, 10,10′-dibromo-9,9′-bianthryl (DBBA), is first evaporated in ultrahigh vacuum on a clean gold (Au) surface. Upon heating to 200° C., catalyzed by the Au, the carbon-bromine bonds (C—Br) are homolytically broken and the resulting radicals polymerize on the surface. Heating to 400° C. causes the polymer to dehydrogenate the carbon-hydrogen (C—H) bonds at internal sites and carbon-carbon (C—C) bonds form, creating the fully cyclized and saturated graphene structure. Using 7-AGNRs synthesized by this process, back-gated FETs with 20-30 nm channel length with Pd (palladium) source-drain (S-D) contacts were successfully demonstrated in Bennett, et. al. To fabricate devices with individual GNRs, they were first grown on a thin ultra-flat gold (111) film supported by a mica substrate. This substrate type was used to facilitate high-resolution scanning probe microscopy (SPM) imaging. The GNRs were then transferred onto silicon wafers with a thin SiO₂ gate oxide by floating the GNR/Au/mica sample on aqueous HCl solution, which delaminates the mica, leaving the thin gold film on the surface of the solution, with the GNRs on the surface of the gold film.

After H₂O rinse, the gold film was picked up by dipping the target substrate with prefabricated back gates. The gold film lies on the target substrate with the GNRs between the gold film and the substrate. A west etch removes the gold without affecting the GNRs. This results in the GNRs lying on the substrate with no gold left. Since these GNRs are ˜30 nm long, electron beam lithography patterns metal S/D contacts to individual GNRs with ˜20 nm gap, where the gap then defines the channel length. Complete details of the fabrication process are provided in Luisier, et. al.

Low on-current (nA range per ribbon) was attributed to high (˜GΩ) contact resistance arising from a large Schottky barrier height at the metal-GNR junction. Drain current vs. Drain voltage (I_{D}-V_{D}) measurements in these devices showed nonlinear behavior consistent with tunnel contacts. In addition, since the ribbon length was limited to <30 nm, overlap contact length is limited to ˜5-10 nm. However, recent experiments on carbon nanotubes, a similar 1D semiconductor, have shown that ultra-short contact lengths of ˜10 nm can perform nearly as well as long contact lengths of >100 nm (Pitner, G.; Hills, G.; Llinas, J. P.; Persson, K. M.; Park, R.; Bokor, J.; Mitra, S.; Wong, H. S. P. “Low-Temperature Side Contact to Carbon Nanotube Transistors: Resistance Distributions Down to 10 nm Contact Length.” Nano Lett. 2019, 19 (2), 1083-1089).

FIG. 2 shows the dependence of the bandgap of the AGNRs on the ribbon width, in units of the number, N, of carbon atoms across the ribbon (Son, Y. W.; Cohen, M. L.; Louie, S. G., “Energy gaps in graphene nanoribbons.” Physical Review Letters 2006, 97 (21), 216803, and Yang, L.; Park, C. H.; Son, Y. W.; Cohen, M. L.; Louie, S. G. “Quasiparticle energies and band gaps in graphene nanoribbons.” Physical Review Letters 2007, 99 (18), 186801). The bandgap is predicted to decrease dramatically for an increase in ribbon width by only a few carbon atoms. These band-structure calculations show that, based on the symmetry of the wave function, AGNRs can be grouped into three distinct families: 3p+1; 3p; and 3p+2; where p is an integer p=1, 2, 3 . . . ranging in band gap from 5.5 eV for N=4 down to ˜1.0 eV for N=11 AGNRs.

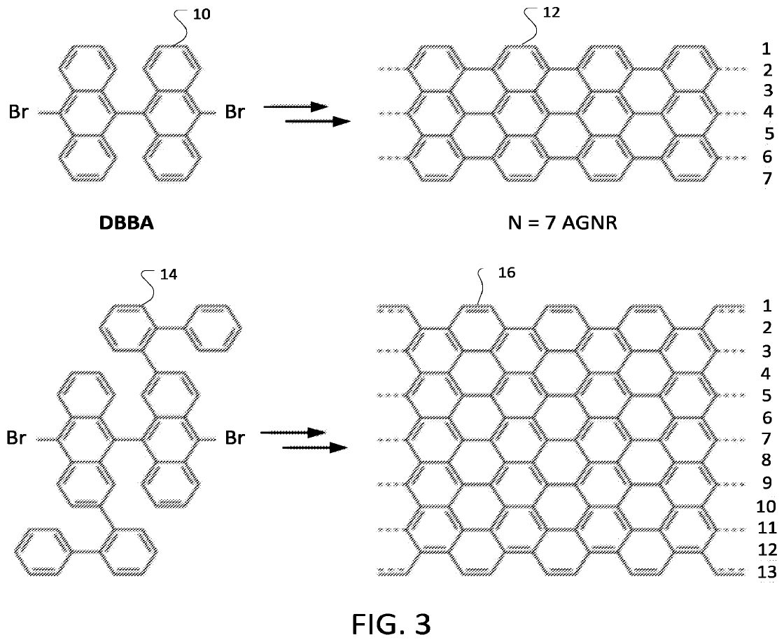

The inventors have since demonstrated bandgap engineering of atomically defined GNRs by tuning the design of the molecular precursors used in their bottom-up synthesis to deterministically modulate the width of ribbons. This approach has shown successful, dramatic lowering of the bandgap of 7-AGNRs (3.9 eV) by extending the width of the molecular precursor (DBBA) to bdpDBBA to produce 13-AGNRs featuring a theoretical bandgap of 2.8 eV, shown in FIG. 3 (Chen, Y. C.; de Oteyza, D. G.; Pedramrazi, Z.; Chen, C.; Fischer, F. R.; Crommie, M. F. “Tuning the Band Gap of Graphene Nanoribbons Synthesized from Molecular Precursors.” ACS Nano 2013, 7 (7), 6123-6128, and Chen, Y. C.; Cao, T.; Chen, C.; Pedramrazi, Z.; Haberer, D.; de Oteyza, D. G.; Fischer, F. R.; Louie, S. G.; Crommie, M. F., “Molecular bandgap engineering of bottom-up synthesized graphene nanoribbon heterojunctions.” Nat. Nanotechnol. 2015, 10 (2), 156-160). FIG. 3 shows the structure of a DBBA molecule 10 and the resulting N=7 AGNR 12, and the extended molecule bdpDBBA 14 and the resulting N=13 AGNR 16.

The inventors have also obtained 9-AGNRs with 2.2 eV bandgap (Talirz, L.; Sode, H.; Dumslaff, T.; Wang, S. Y.; Sanchez-Valencia, J. R.; Liu, J.; Shinde, P.; Pignedoli, C. A.; Liang, L. B.; Meunier, V.; Plumb, N. C.; Shi, M.; Feng, X. L.; Narita, A.; Mullen, K.; Fasel, R.; Ruffieux, P. “On-Surface Synthesis and Characterization of 9-Atom Wide Armchair Graphene Nanoribbons.” ACS Nano 2017, 11 (2), 1380-1388).

Twenty nanometer channel length FET devices were successfully fabricated using these ribbons and similar palladium contacts (Llinas, et. al). For both the N=9 and N=13 GNRFETs (graphene nanoribbons FET), on-current (Iₒₙ) of ˜1 μA per ribbon was observed, a 1000× improvement compared to the N=7 GNRFETs. The increase in Iₒₙ results from two factors. First, the reduction in bandgap resulted in a proportional decrease in the barrier height. In addition, the improved fabrication devices process fabricated the devices with much thinner gate dielectric and a metal gate electrode. This provided improved electrostatic gate control, leading to a significant reduction in the Schottky barrier width. The combination provided the 1000× reduction in contact resistance. However, these devices were still dominated by (˜MΩ) contact resistance and showed tunneling behavior in the I_{D}-V_{D} characteristics.

One strategy for improving the performance of GNR FETs targets the design and synthesis of GNRs with bandgap in the 0.8˜1.5 eV range. One can take advantage of the successful design strategies developed in the preparation of N=13 AGNRs to access the smallest band gaps of the 3p+2 and the 3p AGNR families. More specifically, first the inventors have designed a series of potential molecular precursors and successfully synthesized one example of a molecular precursor for the surface assisted assembly of N=15 AGNRs in the 3p family, with a theoretical band gap ˜1.5 eV. Second, the inventors have designed a series of potential molecular precursors for the synthesis of N=11 AGNRs in the 3p+2 family, with a theoretical band gap ˜1.0 eV, and down to 0.8 eV.

The inventors have successfully demonstrated the fabrication of GNR FET devices from isolated individual N=9 AGNRs. Analogous to the trends observed for the family of 3p+2 GNRs, a lateral extension of the width of the 3p family is also predicted to lead to a narrower bandgap. A new class of molecular precursors for N=9 AGNRs have been recently developed. Based on these initial designs one can extend the width of the AGNR precursor to access N=15 AGNRs having a bandgap ˜1.5 eV.

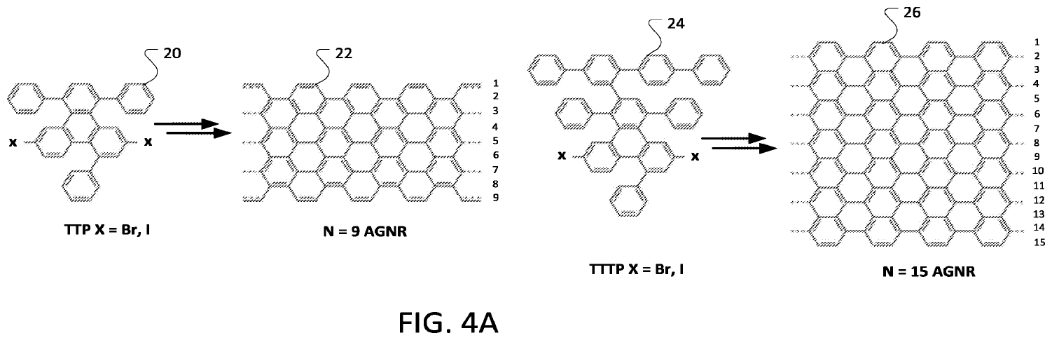

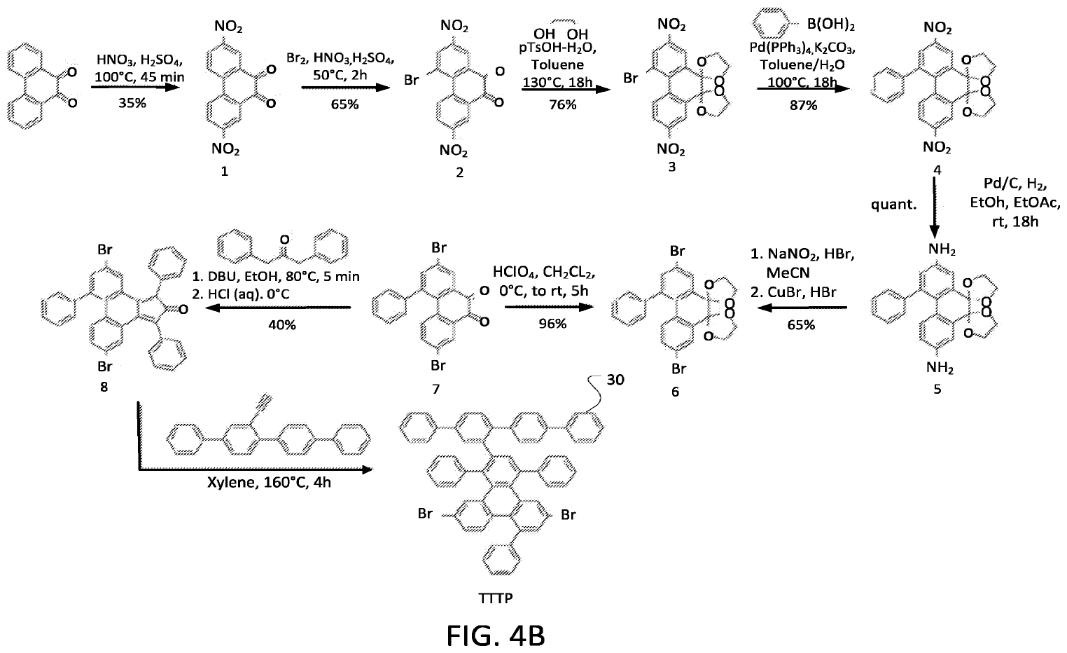

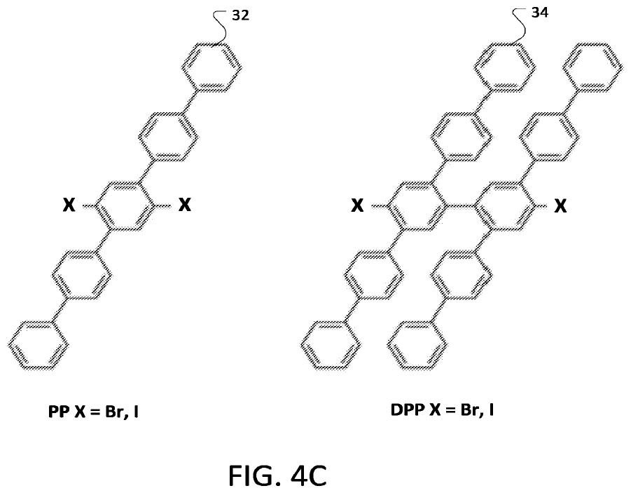

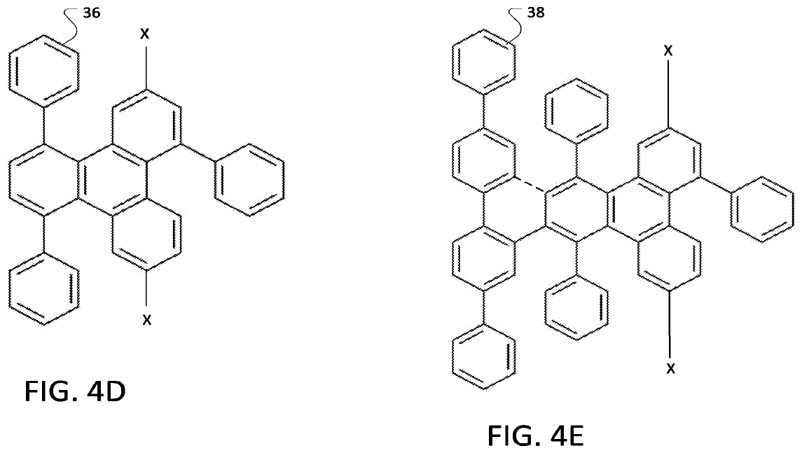

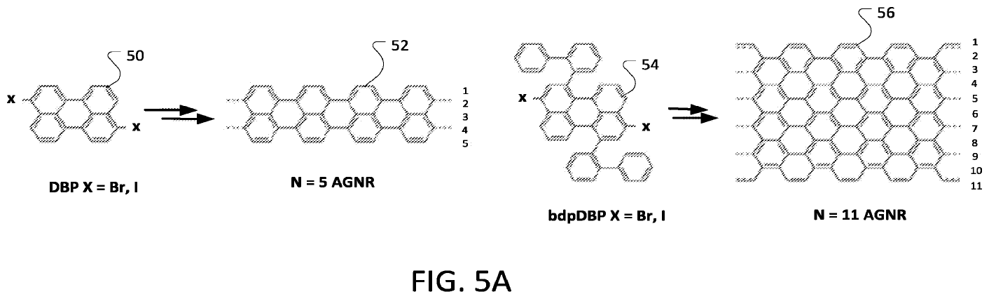

The design embodiments of a molecular precursor for N=15 AGNRs represents a lateral extension of the N=9 building block 22 depicted in FIG. 4A. Expansion of the base of the triangular TTP precursor 20 with a terphenyl unit yields a building block (TTTP) 24 that can polymerize in an alternating pattern into a N=15 AGNR 26. The common central dibromo- or diiodotriphenylene core is a well-established and reliable structural motif that has previously been used in the surface assisted synthesis of “chevron-type” GNRs (Cai, et. al.). FIG. 4B shows the successful synthesis of TTTP 30 by the inventors. A variation of established growth conditions developed for example, TTP, a precursor for N=9 AGNRs, or chevron GNRs can readily be adapted to yield N=15 AGNR from TTTP.

FIG. 4C shows other embodiments of precursors PP 32 and DPP 34, where the X could be either bromine or iodine. FIG. 4D shows another structure of TTP 36, 1,4,8-triphenyltriphenylene. FIG. 4E shows the TTP 38 core with additional phenyl groups to become 2-(terphenyl)-1,4,8-triphenyltriphenylene, or TTP. X could be bromine or iodine, rather than just the bromine shown in FIG. 4B. The structure of FIG. 4E also includes the dashed line to include the isomer for the N=15 precursor.

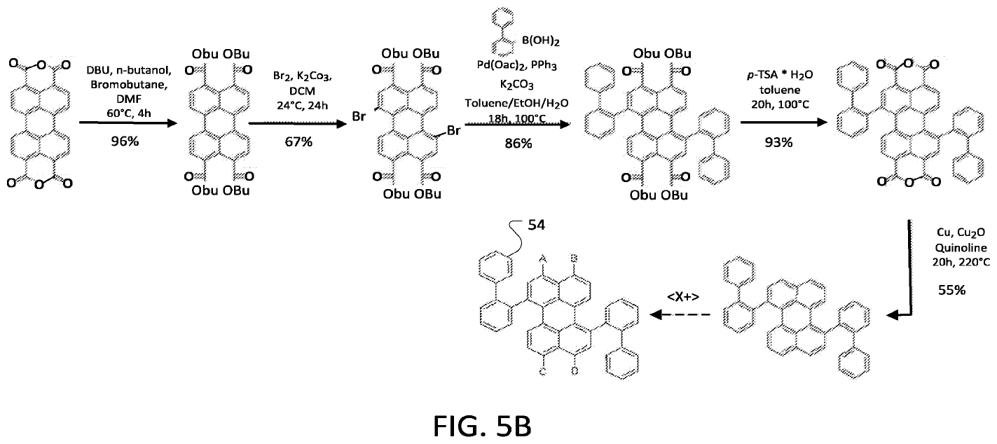

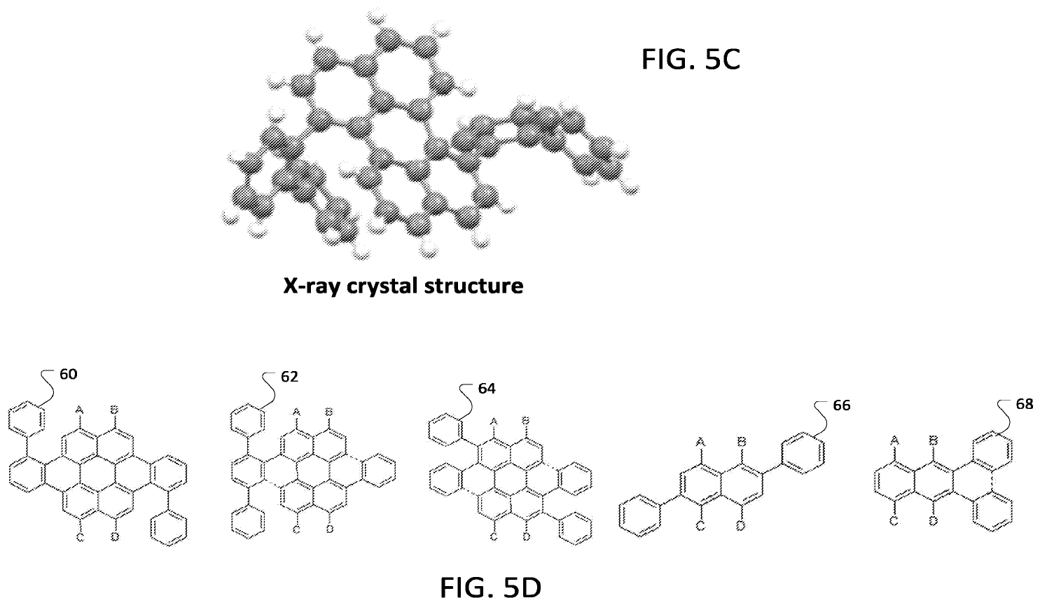

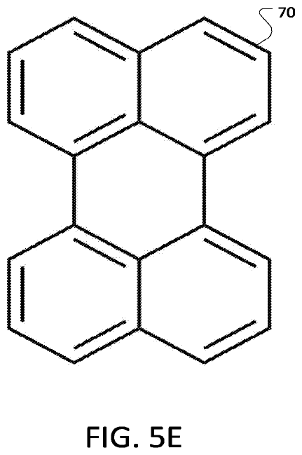

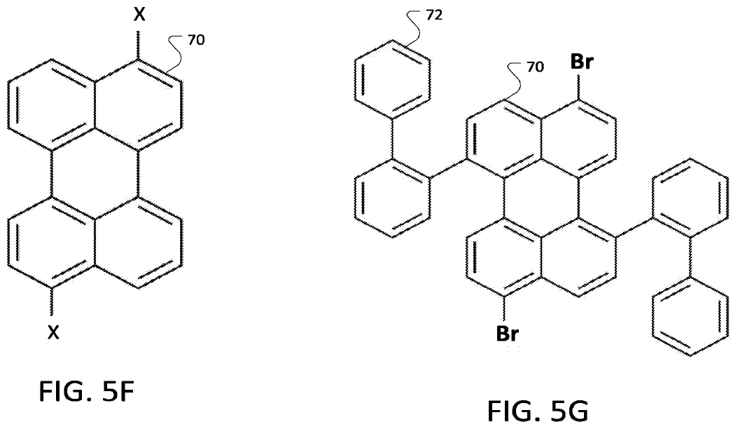

The design of molecular precursors for N=11 AGNRs is depicted in FIGS. 5A-B. One example, DBP, as shown in FIG. 5A at 50, derives from one of the molecular precursors used in the synthesis of other widths of AGNRs, such as the N=5 AGNR 52 shown. Expansion of the dibromoperylene building block with two biphenyl substituents provides access to an AGNR precursor, dbpDBP 54, resulting in a width of N=11 carbon atoms as AGNR 56. FIG. 5B shows an embodiment of the synthesis resulting in dbpDBP 54. The letters A, B, C, and D represent halogens and their locations are the positions to which halogens could attach, and may be selected from iodine, bromine and hydrogen. A, B, C, and D, may all be the same such as all of them being one of either bromine or iodine, or they may all be different, and any combination thereof. In some instances, two of the locations may consist of hydrogen, with the other locations being one of either bromine or iodine. For example, if A and D are one of either bromine or iodine, B and C would be hydrogens. If B and C are one of either bromine or iodine, A and D would be hydrogens. If A and C are one of either bromine or iodine, B and D would be hydrogens.

FIG. 5C shows an x-ray crystal structure of a precursor for N=11 AGNR. FIG. 5D shows embodiments of alternative precursors at 60, 62, 64, and 68 that could also yield N=11 GNRs. The same relationships between A, B, C, and D, as discussed above exist in these structures too.

FIG. 5E shows a perylene chemical structure 70 that may act as a core element of the precursors. As shown in FIG. 5F, the perylene structure 70 with added bromine at the X locations becomes 3,9-dibromoperylene (DPB). As shown in FIG. 5G, the perylene structure 70 with added bromine and phenyls groups such as 72 becomes 1,7-di([1,1′-biphenyl]-2-yl)-4,10-dibromoperylene (dbpDBP). These precursors will be referred to here as dpbDPB.

The GNR surface growth methods developed thus far involve the synthesis of GNRs on atomically flat gold (111) surfaces, yielding atomically precise GNRs, but randomly distributed. One embodiment uses 200 nm thick gold films grown on mica and annealed to produce high quality, ultra-flat (111) oriented films. These substrates are commercially available. Discussed above with regard to the current state of the manufacturing process, the GNRs typically grow on atomically flat gold surfaces on the mica. The process removes the gold film and turns it upside down to put the GNRs between the substrate and then etches the gold film to leave the GNR on the final substrate.

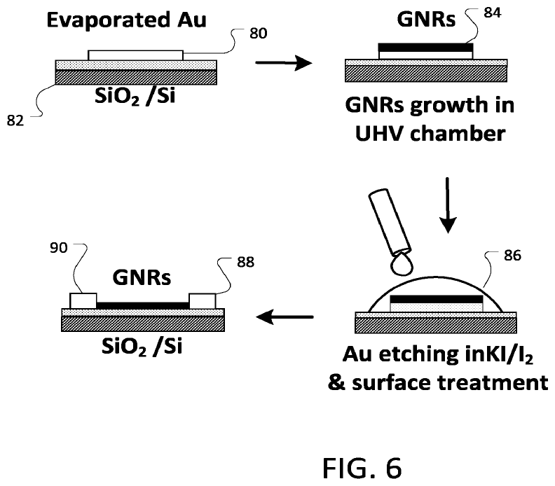

As part of the development of the embodiments, the GNRs grow on gold thin films deposited directly on SiO₂/Si substrates. The subsequent direct removal of the underlying gold film using carefully controlled wet etching, leaving the GNRs intact on the SiO₂ surface. FIG. 6 shows an embodiment of this approach.

The process starts by depositing a thin gold film 80 on SiO₂/Si, or other substrates 82. Next, using the GNR growth processes described above, GNRs 84 are grown on the gold surface by depositing the selected N=11 or N=15 precursor. The precursor is then polymerized, typically by heating. After polymerization, a higher annealing temperature causes cyclodehydrogentation of the polymers to form the AGNRs. Raman spectroscopy characterized the GNRs, since atomic resolution STM imaging will not be possible on such gold surfaces, which are not atomically flat. A carefully controlled wet etch 86 removes the gold. Because the GNRs are chemically inert, they do not solvate into the etch solution and remain on the gold surface as it slowly etches out from under the ribbon. Once the gold disappears, the GNRs reside on the SiO₂/Si surface. The process may then form the source and drain contacts 88 and 90 by electron beam lithography, producing the electronic devices having the GNRs as the channel. Preliminary experiments indicate that this basic concept is valid and practical and can further be optimized by a variety of gold etchants, etch rates and temperatures.

In comparison to the prior art approaches mentioned above, the process involves the gold film lying between the GNRs and the substrate because the substrate upon which the gold resides forms the final substrate. However, one could adapt that process to use the N=11 or N=15 precursors. In this embodiment, the GNRs would be grown on the gold film supported by mica or other temporary substrate, but using the N=11 or N=15 precursors. The process would then continue to polymerization, annealing and then transfer of the gold film face down onto the final substrate. After etching, the N=11 or N=15 GNRs would then reside on the final substrate, ready for electron beam lithography to form the electronic devices.

It is indeed possible to grow aligned GNRs, but this has been achieved only using special “miscut” atomically flat bulk single-crystalline substrates such as gold (788) that exhibit regular linear arrays of single atomic steps which guide the ribbon growth (Linden, S.; Zhong, D.; Timmer, A.; Aghdassi, N.; Franke, J. H.; Zhang, H.; Feng, X.; Mullen, K.; Fuchs, H.; Chi, L.; Zacharias, H., “Electronic Structure of Spatially Aligned Graphene Nanoribbons on Au(788).” Physical Review Letters 2012, 108 (21)).

Referring back to FIG. 4B, the various compounds are identified with numbers 1-8 in reference to the below synthesis processes.

Synthesis of 1

A 250 mL three-neck round bottom equipped with reflux condenser was charged under N₂ with 9,10-phenanthrenequinone (10.0 g, 48.03 mmol) in 98% H₂SO₄ (40 mL) and fuming nitric acid (40 mL). The reaction mixture was stirred at 100° C. for 45 minutes. The reaction mixture was poured over ice and filtered and washed with H₂O. The crude product was purified via hot filtration from acetic acid.

Synthesis of 2

4-Bromo-2,7-dinitro-9,10-phenanthrenequinone was synthesized following literature procedures (Russian Journal of Organic Chemistry 2013, 49(10), 1474-1481).

Synthesis of 3

A 100 mL round bottom was charged under N₂ with 4-Bromo-2,7-dinitro-9,10-phenanthrenequinone (2) (1.30 g, 3.46 mmol) in toluene (23 mL). Ethylene glycol (3.87 mL, 69.27 mmol) and pTsOH.H₂O (98.5 mg, 0.518 mmol) was added and the reaction mixture was refluxed at 130° C. for 18 h with a Dean-Stark trap. The cooled reaction mixture was filtered and washed with cold MeOH and the solids were collected. In order to increase the yield, the filtrate was concentrated on a rotary evaporator. The crude material was diluted with CH₂Cl₂ and washed with H₂O and saturated aqueous NaCl solution, dried over MgSO₄ and concentrated on a rotary evaporator. Column chromatography (SiO₂; 20% EtOAc/Hexane) yielded 3. The products were combined to give 3 (1.23 g, 2.64 mmol, 76%) as a colorless solid. HRMS (ET⁺) m/z: [C₁₈H₁₃BrN₂O₈]⁺ calcd for [C₁₈H₁₃BrN₂O₈]⁺ 463.9855; found 463.9856. ¹H NMR (400 MHz, Chloroform-d) δ 8.81 (d, J=8.8 Hz, 1H), 8.69-8.59 (m, 3H), 8.37 (dd, J=8.9, 2.5 Hz, 1H), 4.60-3.98 (m, 4H), 3.74-3.30 (m, 4H).

Synthesis of 4

A 250 mL three-neck round bottom equipped with reflux condenser was charged under N₂ with 3 (1.59 g, 3.42 mmol), phenylboronic acid (1.25 g, 10.26 mmol), K₂CO₃ (1.42 g, 10.26 mmol), and Pd(PPh₃)₄ (197 mg, 0.171 mmol) in degassed toluene (80 mL) and degassed H₂O (20 mL). The reaction mixture was stirred at 100° C. for 18 h. The reaction mixture was diluted with CH₂Cl₂ and washed with H₂O and saturated aqueous NaCl solution, dried over MgSO₄, and concentrated on a rotary evaporator. Column chromatography (SiO₂; (70% CH₂Cl₂/hexane) yielded 4 (1.38 g, 2.99 mmol, 87%) as a pale yellow solid. HRMS (EI⁺) m/z: [C₂₄H₁₈N₂O₈]⁺ calcd for [C₂₄H₁₈N₂O₈]⁺ 462.1063; found 462.1065. ¹H NMR (400 MHz, CH₂Cl₂-d₂) δ 8.59 (d, J=2.5 Hz, 1H), 8.53 (d, J=2.5 Hz, 1H), 8.31 (d, J=2.5 Hz, 1H), 7.79 (dd, J=8.8, 2.5 Hz, 1H), 7.71-7.08 (m, 6H), 4.27 (br. s, 4H), 3.60 (br. s, 4H). ¹³C NMR (101 MHz, CDCl₃) δ 148.2, 147.8, 143.0, 140.2, 137.5, 137.2, 136.0, 135.9, 131.9, 129.6, 128.9, 128.0, 123.1, 121.9, 121.1, 91.7, 91.3, 61.4.

Synthesis of 5

A 100 mL round bottom was charged with 4 (500 mg, 1.08 mmol) and Pd/C (10% Pd, 230 mg, 0.216 mmol) in 1:1 EtOAc:EtOH (30 mL). The reaction was degassed with H₂ and stirred under 1 atm H₂ at 24° C. for 24 h. The reaction mixture was filtered over Celite and washed with CH₂Cl₂, EtOAc, EtOH and hot toluene. The filtrate was concentrated on a rotary evaporator. The crude material was sonicated in a minimum amount of CH₂Cl₂ (3-4 mL), filtered and washed with hexanes to yield 5 (416 mg, 1.03 mmol, 96%) as an orange solid. HRMS (ESI-TOF) m/z: [C₂₄H₂₂N₂O₄]⁺ calcd for [C₂₄H₂₃N₂O₄]⁺ 403.1652; found 403.1648.

Synthesis of 6

A 25 mL vial was charged with 5 (393 mg, 0.976 mmol) in 48% HBr (0.98 mL) and MeCN (0.20 mL). The reaction mixture was cooled to −5° C. and NaNO₂ (168 mg, 2.44 mmol) in H₂O (0.45 mL) was added dropwise. The reaction mixture was stirred at −5° C. for 40 minutes and was then added dropwise to a solution of CuBr (560 mg, 3.91 mmol) in 48% HBr (7.7 mL) at −5° C. The reaction mixture was stirred at −5° C. for 1 hour, stirred at 24° C. for 2 hours, stirred at 50° C. for 1 hour and at 24° C. for 18 hours. The reaction mixture was quenched by pouring into ice and concentrated aqueous NH₄OH was added until the pH was 10. The reaction mixture was filtered and washed with H₂O. Column chromatography (SiO₂; 0-4% EtOAc/Hexane) yielded 6 (379 mg, 0.714 mmol, 73%) as a colorless solid. HRMS (EI⁺) m/z: [C₂₄H₁₈Br₂O₄]⁺ calcd for [C₂₄H₁₈Br₂O₄]⁺ 527.9572; found 527.9573. ¹H NMR (300 MHz, Methylene Chloride-d₂) δ 7.87 (d, J=2.2 Hz, 1H), 7.79 (d, J=2.3 Hz, 1H), 7.55 (d, J=2.2 Hz, 1H), 7.50-7.09 (m, 5H), 7.05 (dd, J=8.7, 2.3 Hz, 1H), 6.73 (d, J=8.6 Hz, 1H), 4.18 (m, 4H), 3.59 (m, 4H).

Synthesis of 7

A 100 mL two-neck round bottom was charged with 6 (370 mg, 0.698 mmol) in CH₂Cl₂ (48 mL). The reaction mixture was cooled to 0° C. and 70% HClO₄ (3.4 mL) was added dropwise. The reaction mixture was gradually warmed to 24° C. over 2 hours. The reaction mixture was stirred at 24° C. for 3 hours and monitored by TLC. The reaction mixture was quenched with H₂O, extracted with CH₂Cl₂, and washed with H₂O and saturated aqueous NaCl solution, dried over MgSO₄, and concentrated on a rotary evaporator. Column chromatography (SiO₂; benzene) yielded 7 (309 mg, 0.698 mmol, 99%) as an orange solid. HRMS (EI⁺) m/z: [C₂₀H₁₀Br₂O₂]⁺ calcd for [C₂₀H₁₀Br₂O₂]⁺ 439.9048; found 439.9054. ¹H NMR (400 MHz, Methylene Chloride-d₂) δ 8.25 (d, J=2.3 Hz, 1H), 8.13 (d, J=2.3 Hz, 1H), 7.78 (d, J=2.3 Hz, 1H), 7.50-7.42 (m, 3H), 7.37-7.27 (m, 3H), 6.86 (d, J=8.7 Hz, 1H). ¹³C NMR (101 MHz, CDCl₃) δ 180.31, 180.29, 143.62, 142.23, 140.38, 137.49, 134.72, 132.77, 132.75, 132.65, 132.36, 132.02, 129.76, 128.88, 123.64, 123.60, 77.48, 77.16, 76.84.

Synthesis of 8

A 10 mL Schlenk flask was charged under N₂ with 7 (50.0 mg, 0.113 mmol) and diphenylacetone (20.0 mg, 0.0951 mmol) in anhydrous EtOH (2.2 mL). DBU (7.4 μL) was added dropwise and the reaction mixture was stirred at 80° C. for 5 minutes. The reaction mixture was rapidly cooled to 0° C. and 2 M aqueous HCl was added. The reaction mixture was filtered and washed with H₂O and dried under vacuum to yield 8 (60.5 mg) as a green solid. The product was used immediately without further purification.

Synthesis of TTTP

A 5 mL sealable tube was charged under N₂ with 8 (35 mg) and ethynyltrimethylsilane in degassed o-xylene (0.5 mL). The reaction mixture was stirred 145° C. for 18 h. The reaction mixture was concentrated on a rotary evaporator. Column chromatography (SiO₂; 20% CH₂Cl₂/hexane) yielded the TMS protected intermediate (23 mg) as an orange solid. A 10 mL Schlenk flask was charged under N₂ with the TMS protected intermediate (23 mg) in anhydrous THF (1 mL). TBAF (1 M in THF, 0.1 mL) was added dropwise and the reaction mixture was stirred at 24° C. for 40 minutes. The reaction mixture was quenched with MeOH and concentrated on a rotary evaporator. Column chromatography (SiO₂; 20% CH₂Cl₂/hexane), followed by sonication in MeOH and filtration yielded TTP (10.2 mg, 0.0166 mmol, 35% over 3 steps) as a white powder. Recrystallization from CH₂Cl₂/MeOH for surface studies. HRMS (EI⁺) m/z: [C₃₆H₂₂Br₂]⁺ calcd for [C₃₆H₂₂Br₂]⁺ 612.0088; found 612.0083.

Synthesis of 6-I₂

A 25 mL vial was charged with 5 (200 mg, 0.497 mmol) in HCl (2 M, aq, 6 mL) and MeCN (6 mL). The reaction mixture was cooled to −5° C. and NaNO₂ (88 mg, 1.25 mmol) in H₂O (2.4 mL) was added dropwise. The reaction mixture was stirred at −5° C. for 30 minutes. KI (1.98 g, 11.93 mmol) was slowly added to the reaction mixture. The reaction mixture was stirred at 24° C. for 18 hours. The reaction mixture was extracted with CH₂Cl₂, washed with saturated aqueous Na₂S₂O₃, H₂O, and saturated aqueous NaCl solution, dried over MgSO₄, and concentrated on a rotary evaporator. Column chromatography (SiO₂; 5-10% EtOAc/hexane) yielded 6-I₂ (191 mg, 0.306 mmol, 62%) as a pale yellow solid. HRMS (EI⁺) m/z: [C₂₄H₁₈I₂O₄]⁺ calcd for [C₂₄H₁₈I₂O₄]⁺ 623.9295; found 623.9298. ¹H NMR (300 MHz, Methylene Chloride-d₂) δ 8.11 (d, J=2.0 Hz, 1H), 8.04 (d, J=2.0 Hz, 1H), 7.81 (d, J=2.0 Hz, 1H), 7.62-6.99 (m, 6H), 6.65 (d, J=8.5 Hz, 1H), 4.23 (m, 4H), and 3.65 (m, 4H).

Synthesis of 7-I₂

A 100 mL two-neck round bottom was charged with 6-I₂ (191 mg, 0.306 mmol) in CH₂Cl₂ (21 mL). The reaction mixture was cooled to 0° C. and 70% HClO₄ (2.2 mL) was added dropwise. The reaction mixture was gradually warmed to 24° C. over 2 hours and monitored by TLC. The reaction mixture was quenched with H₂O, extracted with CH₂Cl₂, and washed with H₂O and saturated aqueous NaCl solution, dried over MgSO₄, and concentrated on a rotary evaporator. Column chromatography (SiO₂; 5-10% EtOAc/hexane) yielded 7-I₂ (162 mg, 0.303 mool, 99%) as a red-orange solid. HRMS (EI⁺) m/z: [C₂₀H₁₀I₂O₂]⁺ calcd for [C₂₀H₁₀I₂O₂]⁺ 535.8770; found 535.8774. ¹H NMR (600 MHz, Methylene Chloride-d₂) δ 8.45 (d, J=2.1 Hz, 1H), 8.33 (d, J=2.1 Hz, 1H), 8.00 (d, J=2.1 Hz, 1H), 7.51-7.45 (m, 4H), 7.35-7.31 (m, 2H), 6.72 (d, J=8.6 Hz, 1H). ¹³C NMR (151 MHz, CDCl₃) δ 180.2, 180.1, 148.1, 143.4, 143.3, 140.3, 138.8, 138.4, 135.3, 133.4, 132.6, 132.6, 131.9, 129.7, 128.9, 128.8, 95.0, 95.0, 77.4, 77.2, 76.9. HRMS (EI⁺) m/z: [C₂₀H₁₀I₂O₂]⁺ calcd for [C₂₀H₁₀I₂O₂]⁺ 535.8770; found 535.8774.

Synthesis of 8-I₂

A 10 mL Schlenk flask was charged under N₂ with 7-I₂ (60.6 mg, 0.113 mmol) and diphenylacetone (20.0 mg, 0.0951 mmol) in anhydrous EtOH (2.2 mL). DBU (0.02 mL) was added dropwise and the reaction mixture was stirred at 80° C. for 5 minutes. The reaction mixture was rapidly cooled to 0° C. and 2 M aqueous HCl was added. The reaction mixture was filtered and washed with H₂O and dried under vacuum to yield 8-I₂ (71.2 mg) as a green solid. The product was used immediately without further purification.

Synthesis of TTTP-I₂

A 5 mL sealable tube was charged under N₂ with 8-I₂ (71.2 mg) and ethynyltrimethylsilane in degassed o-xylene (1.5 mL). The reaction mixture was stirred 145° C. for 18 h. The reaction mixture was concentrated on a rotary evaporator. Column chromatography (SiO₂; 20% CH₂Cl₂/hexane) yielded the TMS protected intermediate as an orange solid (39.1 mg). A 10 mL Schlenk flask was charged under N₂ with the TMS protected intermediate (39.1 mg) in anhydrous THF (1.5 mL). TBAF (1 M in THF, 0.2 mL) was added dropwise and the reaction mixture was stirred at 24° C. for 1 h. The reaction mixture was quenched with MeOH and concentrated on a rotary evaporator. Column chromatography (SiO₂; 10-20% CH₂Cl₂/hexane), followed by sonication in MeOH and filtration yielded TTP-I₂ (24.1 mg, 0.0.340 mmol, 30% over 3 steps) as a white powder. Recrystallization from CHCl₃/EtOH. HRMS (EI⁺) m/z: [C₃₆H₂₂I₂]⁺ calcd for [C₃₆H₂₂I₂]⁺ 707.9811; found 707.9809. ¹H NMR (600 MHz, CD₂Cl₂, 22° C.) δ=7.99 (d, J=1.8 Hz, 1H), 7.84 (d, J=1.7 Hz, 1H), 7.65-7.58 (m, 3H), 7.57-7.52 (m, 2H), 7.53-7.37 (m, 11H), 7.36-7.32 (m, 2H), 7.13-7.07 (m, 2H). ¹³C NMR (151 MHz, CD₂Cl₂, 22° C.) δ=144.2, 143.6, 143.3, 142.1, 139.5, 139.3, 139.00, 138.9, 138.0, 134.3, 133.9, 133.6, 131.6, 131.3, 131.2, 130.9, 130.8, 130.3, 130.0, 129.9, 129.8, 129.7, 129.6, 129.6, 129.2, 128.2, 128.0, 91.7, and 91.7.

The TTTP precursor may include many different variants, so may be referred to as the N=15 precursor. The below molecules, by themselves, or in combination, will lead to the formation of N=15 AGNRS for use in electronic devices and will be referred to generally as TTTP and its variants. These molecules include: 2-([1,1′:4′,1″:4″,1′″-quaterphenyl]-2″-yl)-6,11-dibromo-1,4,8-triphenyltriphenylene; 2-([1,1′:4′,1″:4″,1′″-quaterphenyl]-2″-yl)-6,11-diiodo-1,4,8-triphenyltriphenylene; 2-([1,1′:4′,1″:4″,1′″-quaterphenyl]-2″-yl)-6,11-dibromo-1,4,9-triphenyltriphenylene; 2-([1,1′:4′,1″:4″,1′″-quaterphenyl]-2″-yl)-6,11-diiodo-1,4,9-triphenyltriphenylene; 5-([1,1′:4′,1″:4″,1′″-quaterphenyl]-2″-yl)-2,9-dibromo-4,7-diphenyldibenzo[fg,op]tetracene; 5-([1,1′:4′,1″:4″,1′″-quaterphenyl]-2″-yl)-2,9-diiodo-4,7-diphenyldibenzo[fg,op]tetracene; 2,9-dibromo-11,13,18,20-tetraphenyltetrabenzo[a,c,hi,qr]pentacene; 2,9-diiodo-11,13,18,20-tetraphenyltetrabenzo[a,c,hi,qr]pentacene; 2″,5″-diiodo-1,1′:4′,1″:4″,1′″:4′″,1″″-quinquephenyl; 4″,5′″-di([1,1′-biphenyl]-4-yl)-4′″,5″-dibromo-1,1′:4′,1″:2″,1′″:2′″,1″″:4″″,1′″″-sexiphenyl; and 4″,5′″-di([1,1′-biphenyl]-4-yl)-4′″,5″-diiodo-1,1′:4′,1″:2″,1′″:2′″,1″″:4″″,1′″″-sexiphenyl.

The dbpDBP precursors may also include many different variants, and may be referred to as the N=11 precursor. The below molecules, by themselves, or in combination, will lead to the formation of N=11 AGNRS for use in electronic devices and will be referred to generally as dbpDBP and variants of dbpDPB. These molecules include: 1,7-di([1,1′-biphenyl]-2-yl)-4,10-dibromoperylene; 1,7-di([1,1′-biphenyl]-2-yl)-3,9-dibromoperylene; 1,7-di([1,1′-biphenyl]-2-yl)-3,10-dibromoperylene; 1,7-di([1,1′-biphenyl]-2-yl)-3,4,9,10-tetrabromoperylene; 1,7-di([1,1′-biphenyl]-2-yl)-4,10-diiodoperylene; 1,7-di([1,1′-biphenyl]-2-yl)-3,9-diiodoperylene; 1,7-di([1,1′-biphenyl]-2-yl)-3,10-diiodoperylene; 1,7-di([1,1′-biphenyl]-2-yl)-3,4,9,10-tetraiodoperylene; 1,9-dibromo-6,14-diphenyldibenzo[a,j]coronene; 1,9-dibromo-3,11-diphenyldibenzo[a,j]coronene1,8-dibromo-3,11diphenyldibenzo[a,j]coronene; 1,8,9,16-tetrabromo-3,11-diphenyldibenzo[a,j]coronene; 1,9-diiodo-6,14-diphenyldibenzo[a,j]coronene; 1,9-diiodo-3,11-diphenyldibenzo[a,j]coronene; 1,8-diiodo-3,11-diphenyldibenzo[a,j]coronene; 1,8,9,16-tetraiodo-3,11-diphenyldibenzo[a,j]coronene; 1-([1,1′:4′,1″-terphenyl]-2′-yl)-4,10-dibromo-7-phenylperylene; 1-([1,1′:4′,1″-terphenyl]-2′-yl)-3,9-dibromo-7-phenylperylene; 1-([1,1′:4′,1″-terphenyl]-2′-yl)-3,10-dibromo-7-phenylperylene; 7-([1,1′:4′,1″-terphenyl]-2′-yl)-3,10-dibromo-1-phenylperylene; 1-([1,1′:4′,1″-terphenyl]-2′-yl)-3,4,9,10-tetrabromo-7-phenylperylene; 1-([1,1′:4′,1″-terphenyl]-2′-yl)-3,9-dibromo-6-phenylperylene; 1,6-([1,1′:4′,1″-terphenyl]-2′-yl)-3,9-dibromo-1-phenylperylene; 1-([1,1′:4′,1″-terphenyl]-2′-yl)-3,10-dibromo-6-phenylperylene; 6-([1,1′:4′,1″-terphenyl]-2′-yl)-3,10-dibromo-1-phenylperylene; 1-([1,1′:4′,1″-terphenyl]-2′-yl)-3,4,9,10-tetrabromo-6-phenylperylene; 1-([1,1′:4′,1″-terphenyl]-2′-yl)-4,10-diiodo-7-phenylperylene; 1-([1,1′:4′,1″-terphenyl]-2′-yl)-3,9-diiodo-7-phenylperylene; 1-([1,1′:4′,1″-terphenyl]-2′-yl)-3,10-diiodo-7-phenylperylene; 7-([1,1′:4′,1″-terphenyl]-2′-yl)-3,10-diiodo-1-phenylperylene; 1-([1,1′:4′,1″-terphenyl]-2′-yl)-3,4,9,10-tetraiodo-7-phenylperylene; 1-([1,1′:4′,1″-terphenyl]-2′-yl)-3,9-diiodo-6-phenylperylene; 6-([1,1′:4′,1″-terphenyl]-2′-yl)-3,9-diiodo-1-phenylperylene; 1-([1,1′:4′,1″-terphenyl]-2′-yl)-3,10-diiodo-6-phenylperylene; 6-([1,1′:4′,1″-terphenyl]-2′-yl)-3,10-diiodo-1-phenylperylene; 1-([1,1′:4′,1″-terphenyl]-2′-yl)-3,4,9,10-tetraiodo-6-phenylperylene; 1,7-dibromo-4,9,12-triphenylnaphtho[1,2,3 ,4-ghi]perylene; 1,7-dibromo-3,9,12-triphenylnaphtho[1,2,3,4-ghi]perylene; 7,14-dibromo-3,9,12-triphenylnaphtho[1,2,3,4-ghi]perylene; 1,6-dibromo-3,9,12-triphenylnaphtho[1,2,3,4-ghi]perylene; 1,6,7,14-tetrabromo-3,9,12-triphenylnaphtho[1,2,3 ,4-ghi]perylene; 1,7-diiodo-4,9,12-triphenylnaphtho[1,2,3,4-ghi]perylene; 1,7-diiodo-3,9,12-triphenylnaphtho[1,2,3,4-ghi]perylene; 7,14-diiodo-3,9,12-triphenylnaphtho[1,2,3,4-ghi]perylene; 1,6-diiodo-3,9,12-triphenylnaphtho[1,2,3,4-ghi]perylene; 1,6,7,14-tetraiodo-3,9,12-triphenylnaphtho[1,2,3,4-ghi]perylene; 1,9-dibromo-3,6-diphenyldibenzo[a,j]coronene; 1,8-dibromo-3,6-diphenyldibenzo[a,j]coronene; 1,8-dibromo-11,14-diphenyldibenzo[a,j]coronene; 1,8,9,16-tetrabromo-3,6-diphenyldibenzo[a,j]coronene; 1,9-diiodo-3,6-diphenyldibenzo[a,j]coronene; 1,8-diiodo-3,6-diphenyldibenzo[a,j]coronene; 1,8-diiodo-11,14-diphenyldibenzo[a,j]coronene; 1,8,9,16-tetraiodo-3,6-diphenyldibenzo[a,j]coronene; 4,10-dibromo-1,2,7,8-tetraphenylperylene; 3,9-dibromo-1,2,7,8-tetraphenylperylene; 3,10-dibromo-1,2,7,8-tetraphenylperylene; 3,4,9,10-tetrabromo-1,2,7,8-tetraphenylperylene; 4,10-diiodo-1,2,7,8-tetraphenylperylene; 3,9-diiodo-1,2,7,8-tetraphenylperylene; 3,10-diiodo-1,2,7,8-tetraphenylperylene; 3,4,9,10-tetraiodo-1,2,7,8-tetraphenylperylene; 1,9-dibromo-7,15-diphenyldibenzo[a,j]coronene; 1,9-dibromo-2,10-diphenyldibenzo[a,j]coronene; 1,8-dibromo-2,10-diphenyldibenzo[a,j]coronene; 1,8,9,16-tetrabromo-2,10-diphenyldibenzo[a,j]coronene; 1,9-diiodo-7,15-diphenyldibenzo[a,j]coronene; 1,9-diiodo-2,10-diphenyldibenzo[a,j]coronene; 1,8-diiodo-2,10-diphenyldibenzo[a,j]coronene; 1,8,9,16-tetraiodo-2,10-diphenyldibenzo[a,j]coronene; 1,5-dibromo-3,7-diphenylnaphthalene; 1,5-dibromo-2,6-diphenylnaphthalene; 1,4-dibromo-2,6-diphenylnaphthalene; 1,4,5,8-tetrabromo-2,6-diphenylnaphthalene; 1,5-diiodo-3,7-diphenylnaphthalene; 1,5-diiodo-2,6-diphenylnaphthalene; 1,4-diiodo-2,6-diphenylnaphthalene; 1,4,5,8-tetraiodo-2,6-diphenylnaphthalene; 1,5-dibromo-2,3-diphenylnaphthalene; 1,4-dibromo-2,3-diphenylnaphthalene; 1,4-dibromo-6,7-diphenylnaphthalene; 1,4,5,8-tetrabromo-2,3-diphenylnaphthalene; 1,5-diiodo-2,3-diphenylnaphthalene; 1,4-diiodo-2,3-diphenylnaphthalene; 1,4-diiodo-6,7-diphenylnaphthalene; and 1,4,5,8-tetraiodo-2,3-diphenylnaphthalene.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An N=15 precursor comprising one of either triphenyltriphenylene (TTTP) or a variant of TTTP.

2. The precursor as claimed in claim 1, wherein the precursor comprises a compound having the chemical structure: 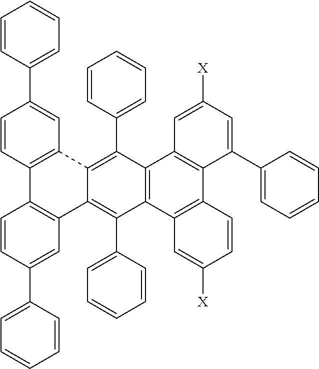
where X is one of either bromine or iodine.

3. The precursor as claimed in claim 1, wherein the precursor comprises a compound having the chemical structure: 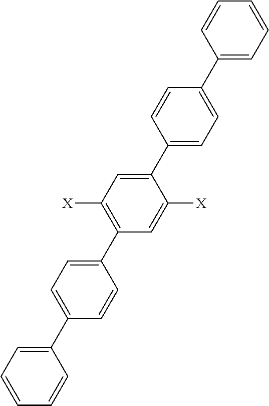
where X is one of either bromine or iodine.

4. The precursor as claimed in claim 1, wherein the precursor comprises a compound having the chemical structure: 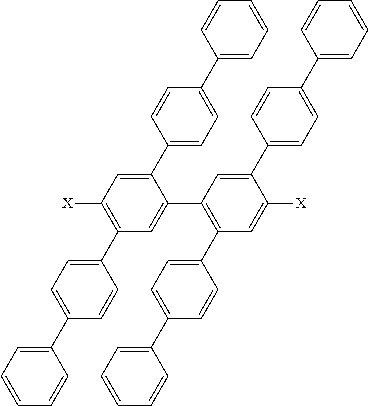
where X is one of either bromine or iodine.

5. An N=11 precursor comprising one of either di-biphenyl dibromoperylene (dpbDBP) or variants of dpbDBP.

6. The precursor as claimed in claim 5, wherein the precursor comprises a compound having the chemical structure: 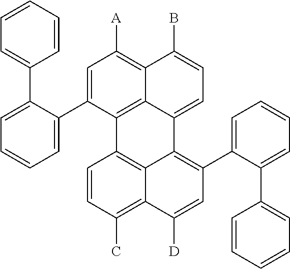
where A, B, C, and D, are each selected from bromine, iodine, and hydrogen.

7. The precursor as claimed in claim 5, wherein the precursor comprises a compound having the chemical structure: 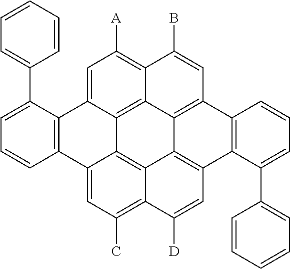
where A, B, C, and D, are each selected from bromine, iodine, and hydrogen.

8. The precursor as claimed in claim 5, wherein the precursor comprises a compound having the chemical structure: 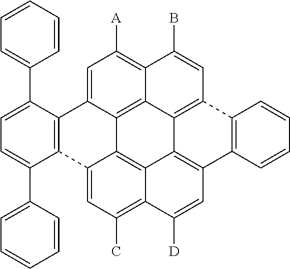
where A, B, C, and D, are each selected from bromine, iodine, and hydrogen.

9. The precursor as claimed in claim 5, wherein the precursor comprises a compound having the chemical structure: 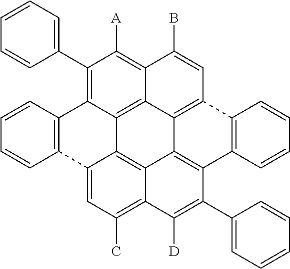
where A, B, C, and D, are each selected from bromine, iodine, and hydrogen.

10. The precursor as claimed in claim 5, wherein the precursor comprises a compound having the chemical structure: 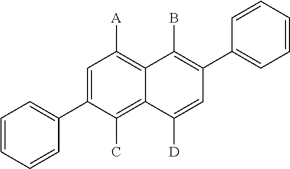
Where A, B, C, and D, are each selected from bromine, iodine, and hydrogen.

11. The precursor as claimed in claim 5, wherein the precursor comprises a compound having the chemical structure: 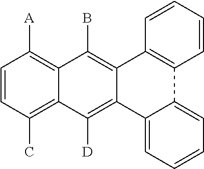
where A, B, C, and D, are each selected from bromine, iodine, and hydrogen.

12. An electronic device having a channel between two terminals, wherein the channel comprises a graphene nanoribbon having a width of one of either N=11 or N=15.

13. (canceled)

14. The electronic device of claim 12, wherein the graphene nanoribbon has a band gap of 1.0 eV or lower.

15. (canceled)

16. A method of forming a graphene nanoribbon, comprising:
depositing a gold film on a substrate;
depositing a graphene nanoribbon precursor onto the gold film;
polymerizing the precursor to produce polymers;
annealing the polymers to cause cyclodehydrogenation of the polymers and form armchair graphene nanoribbons; and
etching the gold film to remove the gold film and such that the graphene nanoribbons reside directly on the substrate.

17. The method as claimed in claim 16, wherein the graphene nanoribbon precursor comprises an N=11 precursor.

18. The method as claimed in claim 17, wherein the N=11 precursor comprises one of either di-biphenyl dibromoperylene (dpbDBP) or variants of dpbDBP.

19. The method as claimed in claim 16, wherein the graphene nanoribbon precursor comprises an N=15 precursor.

20. The method as claimed in claim 19, wherein the N=15 precursor comprises one of either triphenyltriphenylene (TTTP) or a variant of TTTP.

21. The method as claimed in claim 16, further comprising forming contacts at either end of the graphene nanoribbon to form an electronic device having the graphene nanoribbon as a channel.

22. A method of forming a graphene nanoribbon, comprising:
depositing a gold film on a temporary substrate;
depositing one of either an N=11 or a N=15 graphene nanoribbon precursor onto the gold film;
polymerizing the precursor to produce polymers;
annealing the polymers to cause cyclodehydrogenation of the polymers and form armchair graphene nanoribbons on the gold film;
separating the gold film from the temporary substrate;
mounting the gold film to a final substrate such that the graphene nanoribbons lie between the gold film and the final substrate; and
etching the gold film to remove the gold film and leave the graphene nanoribbons directly on the final substrate.
